(19) United States
(12) Patent Application Publication
(10) Pub. No.: US 2007/0193051 A1
(43) Pub. Date: Aug. 23, 2007

(54) Template for cutting material for an endless chain quilt

(75) Inventor: Cheryl Winslow, West Milford, NJ (US)

Correspondence Address: STEPTOE & JOHNSON LLP, 1330 CONNECTICUT AVENUE, N.W., WASHINGTON, DC, 20036, US

(73) Assignee: Cheryl Winslow, West Milford, NJ (US)

(21) Appl. No.: 11/699,452

(22) Filed: Jan. 30, 2007

Related U.S. Application Data
(60) Provisional application No. 60/762,872, filed on Jan. 30, 2006.

(51) Int. Cl. B43L 7/00

(52) U.S. Cl. 33/566

(57) ABSTRACT

A cutting template is provided. The template includes a guide surface with a plurality of parallel first marking lines and a plurality of first grooves in the guide surface. The grooves form a substantially zigzag pattern across pathways defined by the first plurality of marking lines. A plurality of second marking lines are also in the guide surface, and define at least two sides of a predetermined shape. A plurality of second grooves are also in the in the guide surface, and define at least two sides of the predetermined shape.

### CROSS REFERENCE TO RELATED APPLICATIONS

The instant application claimed priority to U.S. Provisional Patent application 60/762,872 filed on Jan. 30, 2006, the contents of which are incorporated by reference herein in its entirety.

### BACKGROUND OF THE INVENTION

1. Field of the Invention

The present invention relates to a template for cutting material in quilt. For specifically, the present invention relates to a template for cutting pieces used to assemble a hexagon within an endless chain quilt.

2. Discussion of Background Information

The Endless Chain Quilt was first seen about 1860. It is called an endless chain because it is made of smaller hexagonal blocks that connect together to form a quilt of any desired size. An example of such a hexagon block is shown in FIG. 2, and includes thirteen (13) pieces. Six identical pieces labeled “A” are trapezoids with a substantially overall triangular shape. Although the “A” pieces are technically trapezoids, they are referred to herein as “triangular” or “triangles,” which Applicant defines to include both a three sided figure and/or a figure with more than three sides yet which has an overall substantially triangular shape. “A” in FIG. 2 is a non-limiting example of the latter.

Another six identical pieces labeled “B” is a trapezoid with an approximately 60° corner point at the wide end. Although the “B” pieces are technically five-sided figures, they are referred to herein as “trapezoid” which Applicant defines to include both a four sided figure and/or a figure with more than four sides yet which has an overall substantially trapezoid shape. “B” in FIG. 2 is a non-limiting example of the latter.

Shapes A and B alternate to form the hexagon. The center of the block has an appliqued circle or oval (collectively herein as “circle” or “circular”).

It would not be an easy task to match the 11 seams on the wedges due to the bulk of seam allowances. The wedges end short of the middle to reduce the bulk in the center. The center circle covers the open middle of the block. The circle is most often appliqued after the wedges are sewn together. Applique is a technique that can be done by hand (most often) or by machine to attach a one piece of fabric on top of another with hidden stitches. The most common sizes for the hexagonal block (measured from flat side to flat side) are 8 inches, 10 inches, and 12 inches. The most labor intensive step in creating this quilt pattern is cutting the individual pieces.

Today's quilters more commonly use a rotary cutter rather than scissors. The rotary cutter is essentially a razor blade in the shape of a wheel on a handle. It is used along with a Plexiglas ruler and a self healing mat. It allows the quilter to cut accurate quilt pieces quickly. Most often quilts are made from basic squares, rectangles, and triangles. Blocks for quilts are most often 4-sided.

The hexagon block is less common in the quilting world. The quilter must start and stop the seam at each block corner. The wedge shaped pieces would normally be cut using templates, cut to the shape plus seam allowances (standard of ¼″). The problem with such templates is that they shift and the quilter must be able to move around them to safely cut. This is often done one piece at a time.

### SUMMARY OF THE INVENTION

According to an embodiment of the invention, a cutting template is provided. The template includes a guide surface with a plurality of parallel first marking lines and a plurality of first grooves in the guide surface. The grooves form a substantially zigzag pattern across pathways defined by the first plurality of marking lines. A plurality of second marking lines is also in the guide surface, and defines at least two sides of a predetermined shape. A plurality of second grooves are also in the in the guide surface, and define at least two sides of the predetermined shape.

### BRIEF DESCRIPTION OF THE DRAWINGS

The present invention is further described in the detailed description which follows, in reference to the noted plurality of drawings by way of nonlimiting examples of certain embodiments of the present invention, in which like numerals represent like elements throughout the several views of the drawings, and wherein:

FIG. 1 is a top view of an embodiment of the invention.

FIG. 2 is a top view of a hexagonal block used in making an endless quilt.

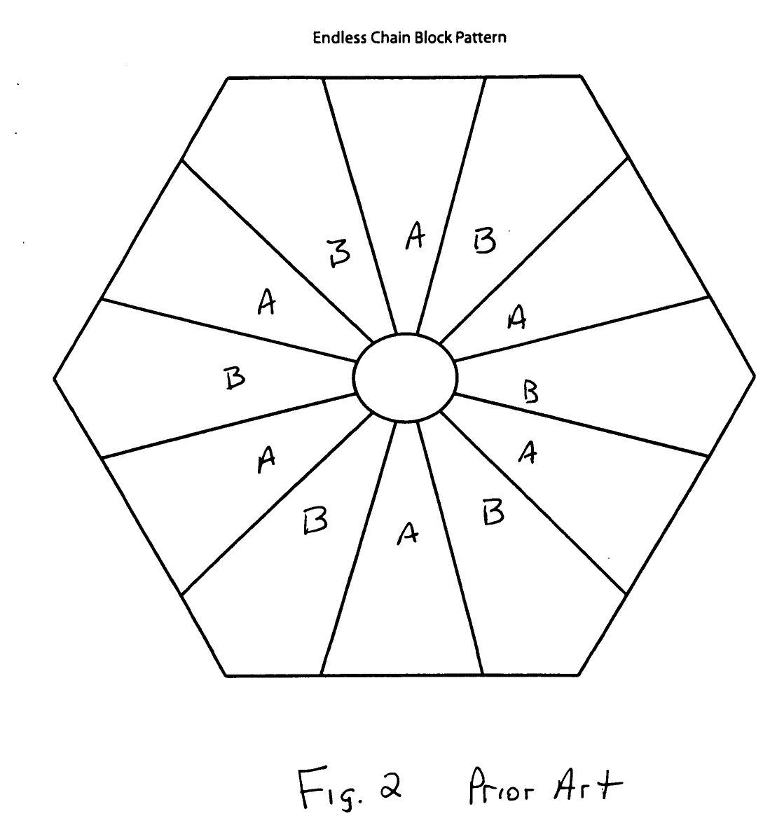

FIG. 3 is a top view of an embodiment of the invention.

### DETAILED DESCRIPTION OF THE EXEMPLARY EMBODIMENT

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

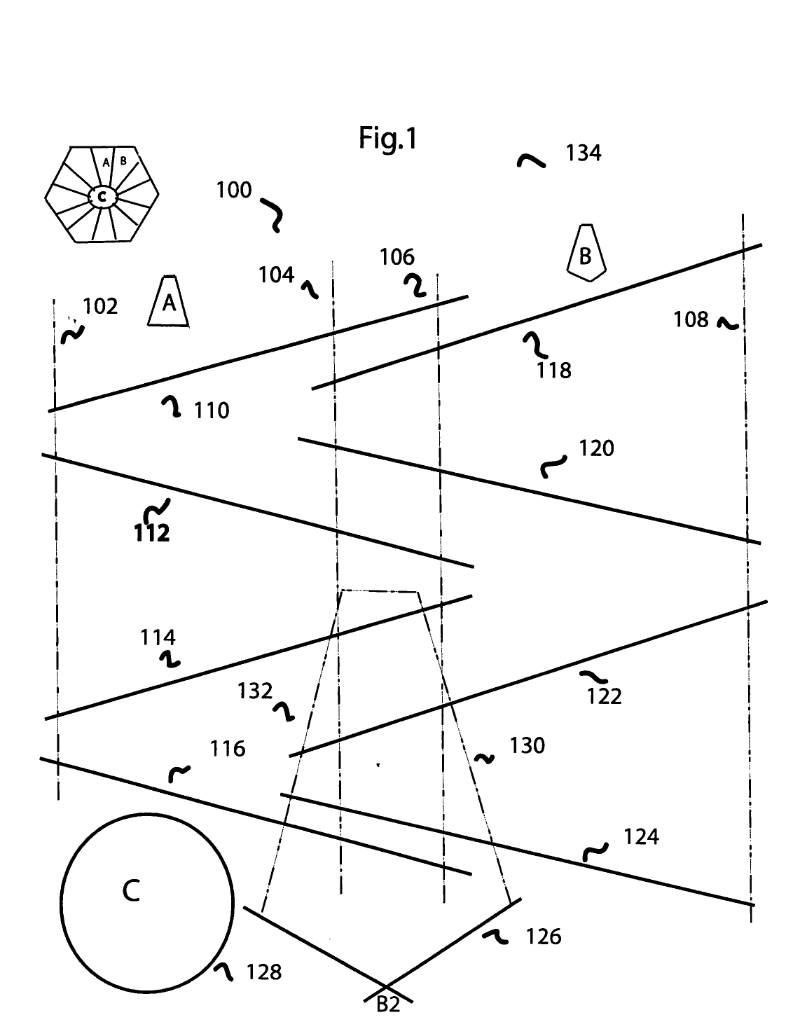

Referring now to FIG. 1, an embodiment of a cutting guide is shown at 100. The guide is preferably made from translucent or transparent Plexiglas or plastic ⅛″ thick, although other materials and thicknesses could be used. Dashed lines in the figure are etched or printed on guide 100 to provide marker lines. The solid lines are grooves in guide 100 through which a cutting tool can pass to cut fabric beneath guide 100. The grooves are preferably as narrow as possible to accurately allow a cutting blade to cut fabric in the desired shape.

The desired fabric is first cut into a strip of a pre-determined width to make either piece A or B. The strips are stacked 4 to 6 layers deep, and guide 100 is placed thereon. Since guide 100 is translucent or transparent, the user can see the fabric under the guide and move guide 100 into its desired position.

To cut the triangular pieces “A” the underlying fabric should be cut a width designated by marking lines 102 and 106, which are preferably 4½″ apart. The user adjusts the position of guide 100 to bring the edges of the layered fabric into alignment with marking lines 102 and 106 to properly align the grooves. The user than inserts a cutting blade through groove 110 to cut the underlying fabric at an angle. A subsequent cut through groove 112 will separate a pile of triangular pieces from the remaining fabric. A subsequent cut through groove 116 will create yet another pile of triangular pieces. The process continues with as many grooves as are available. Four grooves 110, 112, 114, 116 are shown in FIG. 1, but any number may be used.

Since each set of triangular pieces are cut as alternating and adjacent pieces, the user does not need to move the template during cutting and no fabric is wasted. With six layers of fabric, three cuts are sufficient to create enough A pieces for two hexagonal blocks without moving guide 100.

The same process applies to cut the trapezoid pieces B, for which the underlying fabric should be cut a width designated by marking lines 104 and 108, which are preferably 5″ apart. The edges of the layered cloth are then aligned with marking lines 104 and 108 to properly align the grooves. The user than inserts a cutting blade through groove 118 to cut the underlying fabric at an angle. A subsequent cut through groove 120 will separate a pile of triangular pieces from the remaining cloth. A subsequent cut through groove 122 will create yet another pile of triangular pieces. The process continues with as many grooves as are available. Four grooves 118, 120, 122, 124 are shown in FIG. 1, but any number may be used. Since each set of triangular pieces are cut as alternating and adjacent pieces, no cloth is wasted.

For triangular pieces A, the natural end of the cloth provides the base of the triangular shape, and no further cutting is necessary to form the base. For triangular pieces B, the user rotates guide 100 to bring marking lines 130 and 132 into alignment with the boundaries of the cut triangular edges of the previously cut pieces. Proper alignment will place the “x” shaped groove 126 adjacent the base of the triangular pieces. The user then inserts the cutting tool into groove 126, cutting away material from the base of the triangular pieces to form trapezoids.

Guide 100 can be repositioned to bring marking lines 130 and 132 and groove 126 into alignment with other stacks of triangular pieces B. In the alternative, multiple sets of grooves and marking lines may chain together in a manner similar to the template for pieces A and B.

The pattern of an endless quilt has the A pieces at slightly less than 30 degrees, preferably approximately 28 degrees, and the B pieces at slightly more than 30 degrees, preferably 32 degrees. The various cutting grooves are aligned to create wedges of corresponding angles. However, the invention is not so limited, and any appropriate angle may be provided as needed for the quilt design. Similarly, the position of the grooves and marking lines may be placed in any appropriate position to change the size or shape of the pieces to be cut, e.g., to make larger pieces for larger hexagonal blocks.

Guide 100 may have a small alignment guide 134 of etched or printed lines for piecing the shapes A and B together. When sewing the wedges in an alternating fashion there is a small triangle that sticks out. The etched lines will show the shapes of the pieces overlaid to identify the small triangle. Seam lines are matched as well as the outer corner point to find this shape. The quilter can lay the cut fabric over the guide to align quickly and sew.

Guide 100 may also include a circle template 128, which is of the appropriate size to cut the center circle of the hexagonal block. Circle template 128 may be printed or etched such that the line can be traced onto another piece of fabric. In the alternative, circle template 128 may be a cutout from guide 128 to act as a stencil.

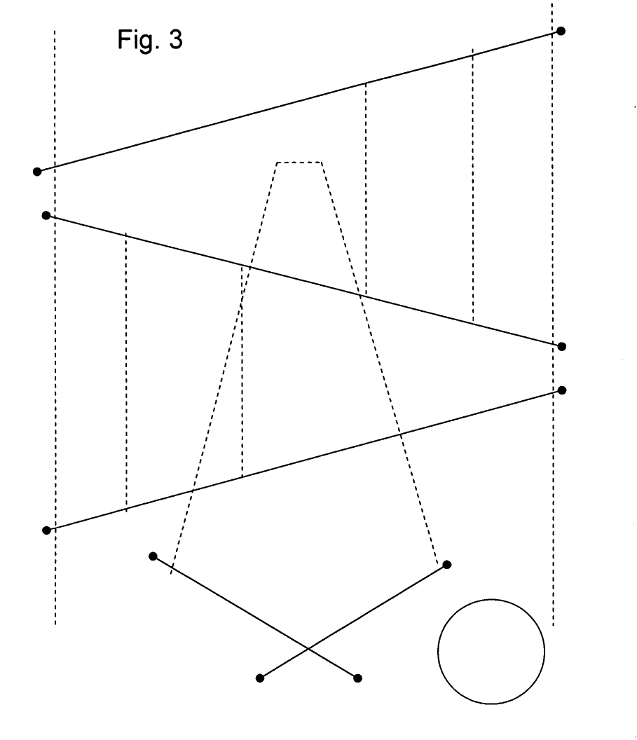

Referring now to FIG. 3, another embodiment of a cutting guide is shown at 300. The guide is preferably made from translucent or transparent Plexiglas or plastic ⅛″ thick, although other materials and thicknesses could be used. Dashed lines in the figure are etched or printed on guide 300 to provide marker lines. The solid lines are grooves in guide 300 through which a cutting tool can pass to cut fabric beneath the tool. The grooves are preferably as narrow as possible to accurately allow a cutting blade to cut fabric in the desired shape.

Guide 300 has all of the general characteristics of guide 100, save that it only has one set of patterns rather than 2, with a common angle of roughly 30 degrees. Different marking lines are spaced apart to allow for cutting fabric of different widths, e.g., 8 inches or 12 inches. Similar to guide 100, the marking lines are aligned with the underlying fabric is appropriate, and triangular shapes are formed in a zigzag pattern to allow for alternate cutting motions. Guide 300 can be realigned to move the “B” cutting template into position to form trapezoids. Guide 300 can include one or more circular templates sized to correspond to the sizes of the triangular pieces that can be cut from the template.

As shown in FIG. 3, the ends of the grooves (shown by black circles) may have a larger width than the rest of the grooves to allow for easier insertion of the cutting tool.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

By way of examples, the marking lines in the embodiments physically cross the corresponding grooves. However, the invention is not so limited, as the marking lines may be smaller and not cross the grooves. In both cases, the marking lines define a pathway (e.g., the line itself, or the path created by the direction of the line) which crosses with the grooves.

What is claimed is:

1. A cutting template, comprising:
a guide surface;
a plurality of parallel first marking lines in said guide surface;
a plurality of first grooves in the guide surface, said grooves forming a substantially zigzag pattern across pathways defined by said first plurality of marking lines;
a plurality of second marking lines in said guide surface, said second marking lines defining at least two sides of a predetermined shape; and
a plurality of second grooves in the guide surface, the second grooves defining at least two sides of the predetermined shape.

2. The cutting template of claim 1, further comprising a cutting tool insertable through said first and second grooves.

3. The cutting template of claim 1, wherein said first and second grooves and said first and second marking lines have proportional dimensions to define shapes for use in a endless quilt pattern.

4. The cutting template of claim 1, further comprising a substantially circular cutout in said guide surface.

5. The cutting template of claim 4, wherein said pluralities of first and second grooves, said substantially circular cutout, and said pluralities of first and second marking lines have proportional dimensions to define shapes for use in a endless quilt pattern.

6. The cutting template of claim 1, wherein said plurality of first marking lines comprises two marking lines spaced apart a distance for cutting a first part of an endless quilt.

7. The cutting template of claim 1, wherein said plurality of first marking lines comprises at least three marking lines spaced apart a distance for cutting a first part of an endless quilt to at least first and second sizes.

8. The cutting template of claim 1, wherein said plurality of first marking lines and said plurality of first grooves collectively delineate a plurality of triangular shapes.

9. The cutting template of claim 8, wherein said plurality of triangular shapes are adjacent and alternating.

10. The cutting template of claim 8, wherein said plurality of triangular shapes have alternating sides.

11. The cutting template of claim 1, wherein said plurality of second marking lines and said plurality of second grooves collectively define at least one trapezoid shape.

12. The cutting template of claim 1, wherein said guide surface is transparent or translucent.

13. The cutting template of claim 1, wherein said predetermined shape is a trapezoid.

14. The cutting template of claim 1, wherein:
said plurality of first marking lines and said plurality of first grooves collectively delineate a plurality of triangular shapes; and
said plurality of second marking lines and said plurality of second grooves collectively define at least one trapezoid shape.

15. The cutting template of claim 1, wherein said at least one trapezoid shape is substantially perpendicular on said guide surface to said plurality of triangular shapes.

16. A method for cutting pieces for an endless quilt using a cutting template, the cutting template including a plurality of marking lines and a plurality of grooves, the method comprising:
placing the cutting template over a plurality of strips of fabric;
aligning at least some of the marking lines over at least some of the edges of the strips of fabric;
inserting a cutting tool through at least some of the grooves to cut the fabric into a plurality of stacks of triangular pieces;
realigning the cutting template to bring at least some marking lines into alignment with at least one edge of at least one stack of triangular pieces;
inserting a cutting tool through at least some of the grooves to cut the at least one stack of triangular pieces into a stack of trapezoid pieces.

17. The method of claim 16, wherein said realigning comprises sliding the cutting template without lifting it from the strips of fabric.

18. The method of claim 16, wherein said inserting a cutting tool through at least some of the grooves to cut the fabric into a plurality of stacks of triangular pieces further comprises cutting the fabric into adjacent and alternating stacks of triangular pieces.
